(19) United States
(12) Patent Application Publication
(10) Pub. No.: US 2010/0332186 A1
(43) Pub. Date: Dec. 30, 2010

(54) Probabilistic Estimation of a Time Interval Between Periodic Events Disturbing a Signal

(76) Inventor: Kevin W. Wilson, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/495,737

(22) Filed: Jun. 30, 2009

(51) Int. Cl. G06F 17/18

(52) U.S. Cl. 702/181

(57) ABSTRACT

The embodiments of the invention disclose a method for a probabalistical determination of a time interval between events, wherein the events periodically disturb a signal. The method determines, as a function of time, probabilities of occurrences of the events based on values of the signal, wherein the signal is Jittered, and determines, based on the probabilities of the occurrences of the events, probabilities of correspondence of a set of possible time intervals to the time interval between the events producing a set of probabilities of the possible time intervals suitable for determining the time interval between the events.

### FIELD OF THE INVENTION

This invention relates generally to a method for determining a time interval between periodic events disturbing a signal, and more particularly to a method for probabilistic estimation of the time interval between events disturbing the signal in real time.

### BACKGROUND OF THE INVENTION

Bearings are ubiquitous, be they plain, ball, roller, needle, tapered, spherical, or thrust; bearings make the world go around and are found in all types of equipment, such as motors, generators, wheels, turbines, disk drives, and jet engines. Although the design of a bearing is extremely simple, a failure in a bearing can lead to catastrophic results. Therefore, it is desired to detect bearing failures in real time.

FIG. 1 shows a ball bearing 110, which includes an inner race 115, an outer race 117, and bearing elements, e.g., balls 119, between the races. As the bearing rotates, the fault causes the bearing to resonate at a frequency that is proportional to an angular acceleration of the bearing. The resonance can be sampled over time as a signal 122.

Typically, the faults is at a single-point, which causes periodic events, which disturb the signal 122 generated by the bearing resulting in peaks 120 in the signal. Ideally, the peaks are periodic and separated by time intervals 125. The signal shown is acceleration (g) as a function of time (t).

Based on the geometry of the bearing and the inter-event intervals, it is possible to distinguish different faults. However, noise can conceal the fault-related periodic events. For example, mechanical noise caused by a bearing slip or variable point of contact of the defect between the ball and the races jitters the signal such that amplitudes 130 and time intervals 131 vary.

One conventional method for measuring the time intervals between events disturbing the signal is to auto-correlate an enveloped signal and to detect peaks at lags corresponding to the characteristic frequencies. Here, the signal 140 is shown as autocorrelation r(t) as a function of lag. However, that method fails in case of a jittered signal, because the autocorrelation is dominated by a few spurious largest-amplitude peaks.

Another method uses bispectral analysis to simultaneously demodulate the signal and detect energy at characteristic frequencies. However, that bispectrum-based method makes an assumption about the periodicity of the signal.

Another method detects faults in the presence of variation of the periodicity of the signal by applying machine learning techniques to feature vectors derived from the signal. However, that method requires training data, and may not generalize well to situations not represented in the training data, making that method useless for real time fault detection.

Hence, it is desired to determine the time interval between period events disturbing a jittered signal, without requiring training.

### SUMMARY OF THE INVENTION

The objective of present invention is to determine the time interval between period events disturbing a Jittered signal, without requiring training.

The embodiments of the invention are based on realization that a posterior probability of a possible time interval between the events is a function of the probabilities of occurrences of the events disturbing the signal as a function of time. Moreover, the probabilities can be determined based on values, e.g., amplitude of acceleration of the signal.

The embodiments of the invention disclose a method for a probabalistical determination of a time interval between events, wherein the events periodically disturb a signal. The method determines, as a function of time, probabilities of occurrences of the events based on values of the signal, wherein the signal is Jittered, and determines, based on the probabilities of the occurrences of the events, probabilities of correspondence of a set of possible time intervals to the time interval between the events producing a set of probabilities of the possible time intervals suitable for determining the time interval between the events.

### BRIEF DESCRIPTION OF THE DRAWINGS

FIG. 1 is a schematic of a bearing fault diagnosis problem solved by embodiments of the invention;

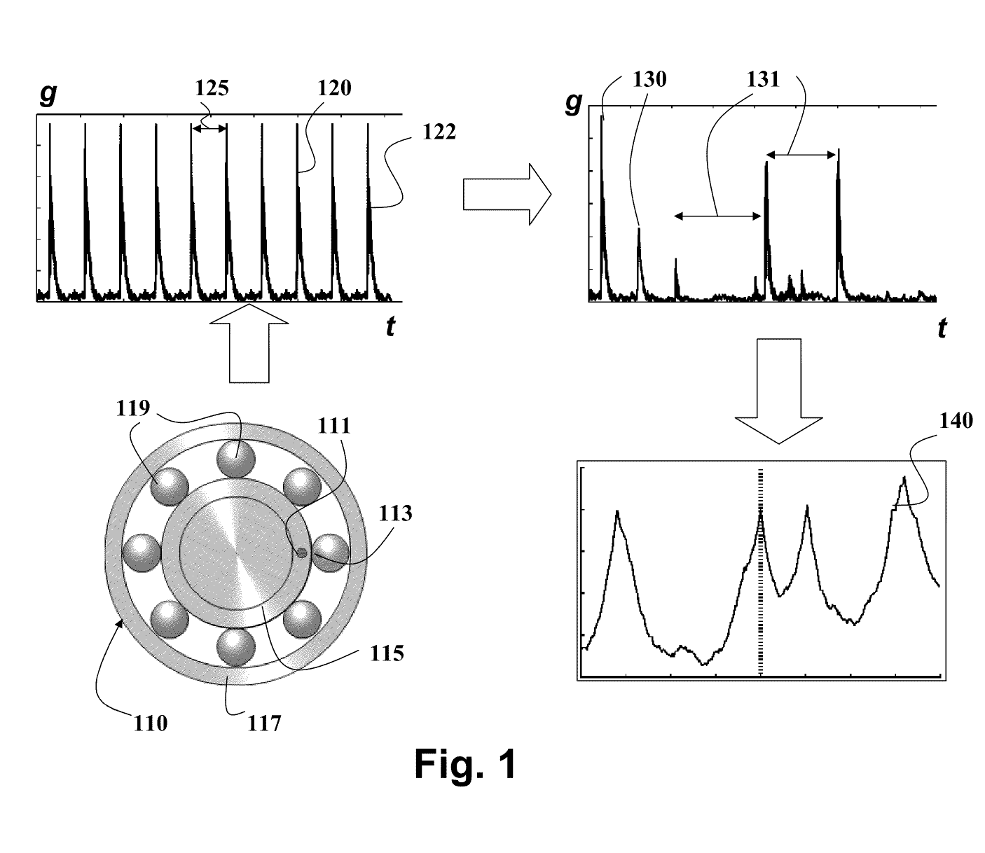

FIG. 2 is a block diagram of a method for determining of a time interval between events disturbing a signal according embodiments of the invention;

FIGS. 3A-3B are graphs of the signal disturbed in part by the events;

FIG. 4 is a histogram of probabilities of occurrences of the events;

FIG. 5 is a histogram of probabilities of possible time intervals; and

FIG. 6 is an example of practical settings of the embodiments of the invention.

### DETAILED DESCRIPTION OF THE PREFERRED EMBODIMENTS

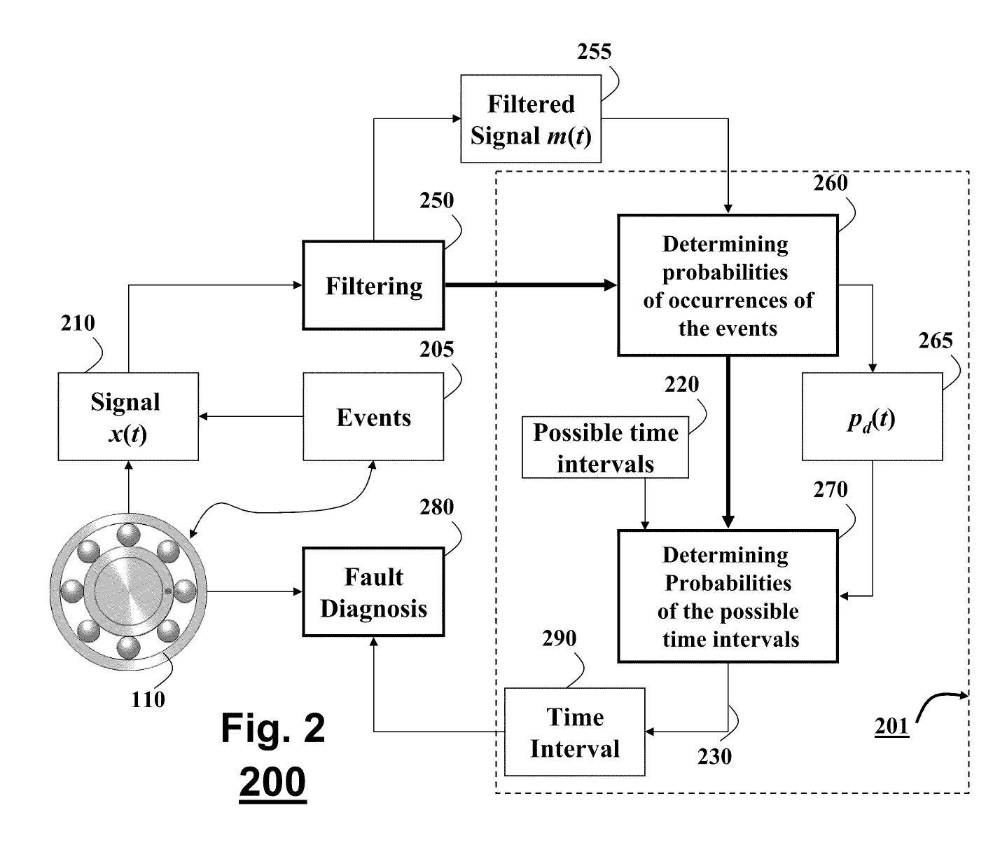

FIG. 2 shows a method 200 for determining a time interval 290 of events 205, wherein the events periodically disturb a signal x(t) 210. Due to noise, and other random influences, the signal 210 is jittered. The jitter includes frequency of successive pulses of the signals, amplitude of the signals, and phase of the signals. Steps of the method are executed by processor 201, which includes a memory, input/output interfaces, and signal processors as known in the art.

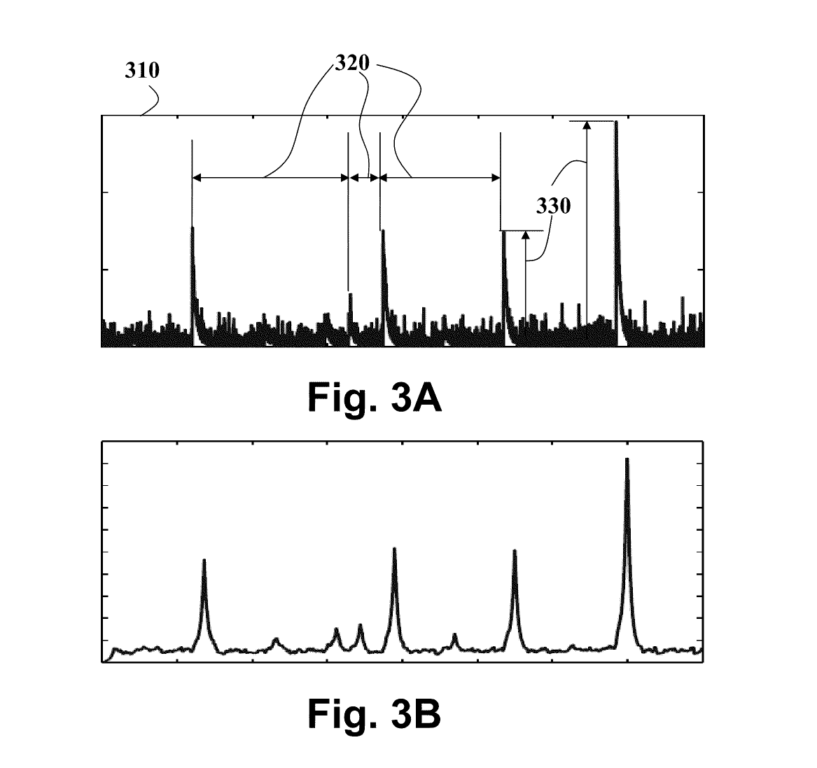

FIG. 3A shows an example 310 of the signal 210. The signal has jittered periods 320. The Jittered period is a time interval between two events of maximum or minimum effect of the characteristic of the signal. Moreover, amplitudes 320 of the signal are also jittered, i.e., vary over time.

In one embodiment, the signal 210 is generated by a failing bearing 110 due to events 205. If the fault is localized, then the events are periodic with time interval 290 between the events. The length of time interval 290 is an important factor for diagnosis 280 of the fault. However, in other embodiments, the signal 210 is any periodic signal subject to jitter, e.g., any electromagnetic signal. Jitter of the signal can be caused, for example, by exponentially distributed white additive background noise.

The embodiments of the invention are based on realization that a posterior probability pᵢ(τ) of a possible time interval τ between the events is a function of the probabilities p_{d}(t) of occurrences of the events disturbing the signal as a function of time. Moreover, the probabilities p_{d}(t) can be determined based on values, e.g., amplitude of acceleration of the signal.

Accordingly, the method 200 determines 260 the probabilities p_{d}(t) 265 of occurrences of the events based on the values of the signal. In one embodiment, we filter 250 the signal to remove noise from the signal producing a filtered signal m(t) 255. In this embodiment, the filtering step uses, e.g., a matched filter, created by averaging the signal in windows including the N largest peaks of the signal. For the purpose of this description, we use signals x(t) and m(t) interchangeably. FIG. 3B shows an example of the signal after filtering. The filtering eliminates background noise to reveal low amplitude events.

The step 260 applies a pointwise transformation p_{d}(t)=g(m(t)), where g(m(t)) is the posterior probability of the occurrence of the event at time t after observing the value of the signal m(t) according to

$$g ( m ) = \frac{{P}_{d} \cdot p ( m \vert d = 1 )}{{P}_{d} \cdot p ( m \vert d = 1 ) + ( 1 - {P}_{d} ) \cdot p ( m \vert d = 0 )} , \qquad ( 1 )$$

where P_{d} is a prior probability of the occurrence of the event, p(m|d=1) is a conditional probability of the occurrence of the event, i.e., observing a value of the signal m(t) given that the event occurs at time t, and p(m|d=0) is a conditional probability of nonoccurrence of the event, i.e., observing a value of the signal m(t), given that the event does not occur at time t.

As defined herein, the prior probability of the occurrence of the event, the conditional probability of the occurrence of the event, and the conditional probability of nonoccurrence of the event, are probability characteristics of the events.

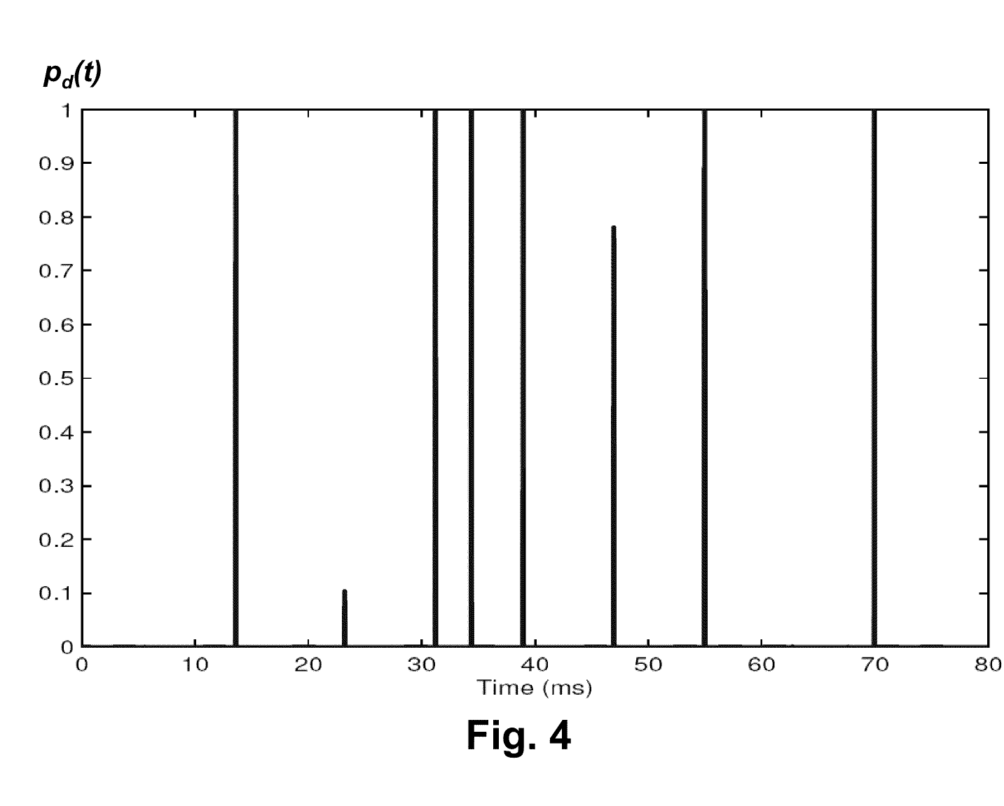

Some embodiments use an observation that the event disturbing the signal increase the value of the signal m(t) for a range of time t in proximate the time of the event. In these embodiments, we filtering the the probabilities of occurrences of the events by preserving only relatively large local maxima of the probabilities p_{d}(t), and set the probabilities p_{d}(t) proximal to each large local maximum to zero. Thus, at times of moderate to large peaks of the signal, the disturbance probability p_{d}(t) is close to 1, and at times with no obvious disturbances present, the probability p_{d}(t) close to 0. Small peaks in the values of the signal produce uncertain matched filter outputs, resulting in intermediate values for p_{d}(t), as shown at FIG. 4.

Based on the probabilities p_{d}(t) 265, the method 200 determines 270 probabilities of a correspondence of possible time intervals 220 to the time interval 290 producing a set of probabilities of the possible time intervals 230. The set 230 is used for determining the time interval between the events. For example, in one embodiment, we select from the set 230 the possible time interval with highest probability. In one embodiment, the possible time intervals 220 are selected based on the geometry of the bearing 110.

The set of probabilities of the possible time intervals does not necessarily include actual probabilities of the correspondence to the time interval 290. In one embodiment, the probabilities are normalized, i.e., relevant to each other, which allows to determine a most likely possible time interval.

The embodiments determine the set of probabilities of the possible time intervals according to

$${p}_{i} ( τ ) ∝ {P}_{i} ( τ ) {\sum }_{t} {p}_{d} ( t ) {p}_{d} ( t - τ ) , \qquad ( 2 )$$

where Pᵢ(τ) is a prior probability over possible time intervals, which is uniform, τ is a value of the possible time interval.

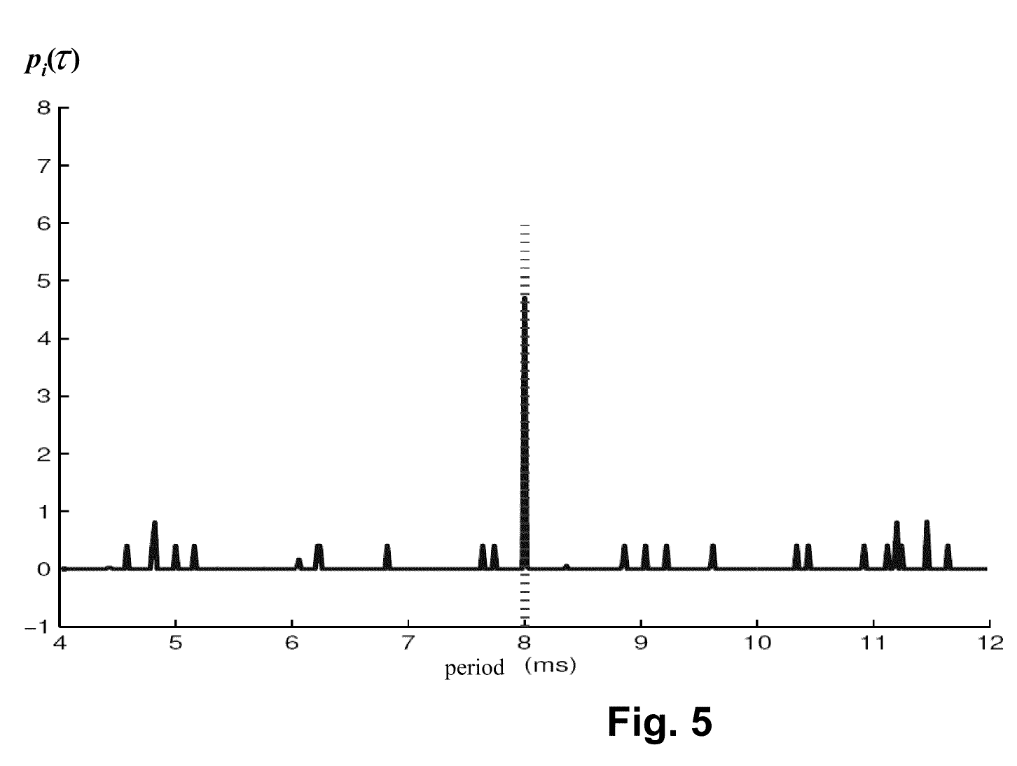

FIG. 5 shows a normalized diagram of the probabilities pᵢ(τ) of the possible time intervals. For example, the probability that the time interval between events is 10 ms is 0, and probability of the time interval is 8 ms is 5. Accordingly, one embodiment determines the period 290 based on the set of probabilities 230 by selecting the possible time interval with the highest probability value.

Probabilities of Occurrences of Events

Typically, most events that disturb the signal result in noticeable peaks in the signal m(t). Hence, we determine a set of local maxima values {m(t₀), . . . , m(t_{M})} of the signal at times {t₀, . . . , t_{M}}, which possibly correspond to occurrence of the events.

In one embodiment, we limit the number of local maxima in the set using a full width half maximum (FWHM) method. The FWHM is an expression of an extent of a function, given by a difference between two extreme values of an independent variable at which the dependent variable is equal to half of its maximum value.

First, we determine a global maximum of the signal m(t) and select m(t₀). Then, we assume that no additional events exist in the region around time t₀ for which m(t)>0.5m(t₀), i.e., a full width half maximum region around t₀.

Next, we determine the largest value of m(t) outside of the region, at time t₁, and also select m(t₁) into the set of local maxima values. Subsequently, we partitioned the signal into the “full width half maximum” regions, and determine the set of local maxima values, and corresponding times.

Next, we determine the probability characteristics of the events based on the set of local maxima values. In one embodiment, we determine the probability p(m|d=1) as a maximum likelihood fit of a log-normal distribution to the set of local maxima values. Other embodiments use different parametric forms for modeling positive-valued data, e.g., normal distribution.

Given the conditional probability p(m|d=1), we fix this distribution as a component of a two-component mixture of log-normal distributions, and use an expectation-maximization (EM) procedure to determine the parameters of a second component and the second component prior probabilities such that the mixture models the full set of values m(t) for all times, and not just for the local maxima values.

After performing the EM, because we have fixed one mixture component to our maximum likelihood fit of p(m|d=1), the second component will represent the signal at non-disturbance times. Therefore, the second component corresponds to p(m|d=0). The prior probability for the component corresponding to p(m|d=1) yields an estimate of the probability P_{d}.

### EFFECT OF THE INVENTION

Embodiments of the invention describe a method for determining a time interval between events, wherein the events disturb a signal. The time interval between the events is used for detecting the characteristic of fault-related disturbances in bearings with single-point defects. The embodiments use a probabilistic model of fault-related vibration disturbances and can be executed in a real time.

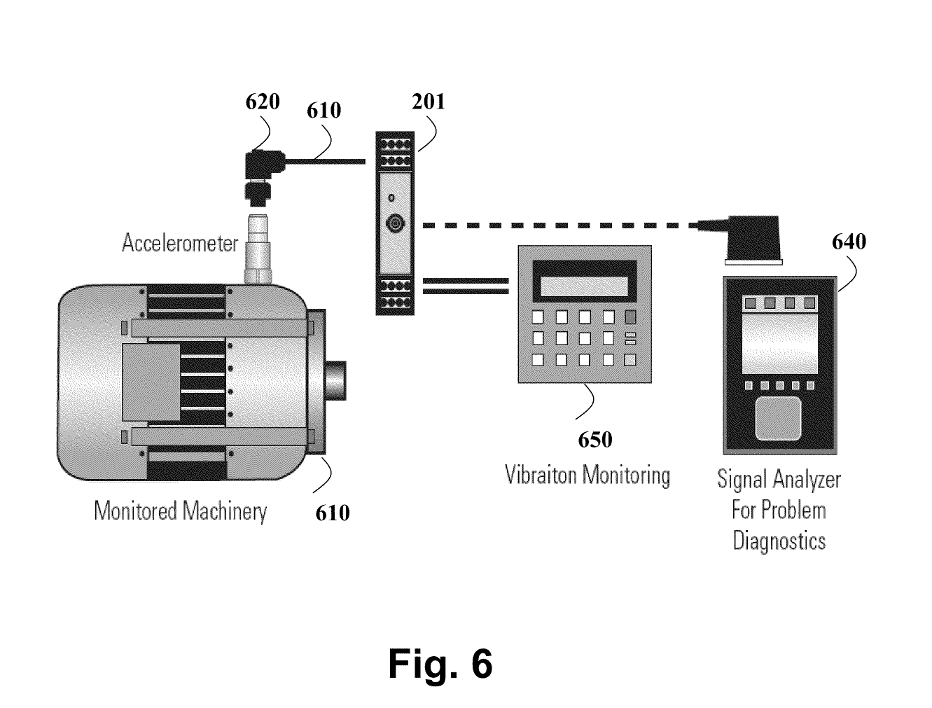

FIG. 6 shows a non-limited example of a setting for machine fault diagnosis method using the embodiments of the invention. The vibration signal 210 of the motor 610 is sensed by an accelerometer 620 and directed 630 to the processor 201 executing the method 200. The result of the executing of the method 200 is directed to an analyzer 640. In addition, the signal 210 is transferred to a vibration monitoring module 650 for further review.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A method for a probabalistical determination of a time interval between events, wherein the events periodically disturb a signal, comprising a processor for executing steps of the method, comprising the steps of:
determining, as a function of time, probabilities of occurrences of the events based on values of the signal, wherein the signal is jittered; and
determining, based on the probabilities of the occurrences of the events, probabilities of correspondence of a set of possible time intervals to the time interval between the events producing a set of probabilities of the possible time intervals suitable for determining the time interval between the events.

2. The method of claim 1, wherein the signal is a vibration signal generated by a bearing due to the events, and wherein the time interval is suitable for diagnosis of the bearing.

3. The method of claim 1, wherein the signal effected by white noise causing the jitter.

4. The method of claim 1, further comprising:
filtering the signal by a matched filter.

5. The method of claim 1, further comprising:
filtering the function of the probabilities of occurrences of the events.

6. The method of claim 1, wherein the determining probabilities of correspondence is based on functional relationship between the probabilities of a possible time interval between the events and the probabilities of the occurrences of the events disturbing the signal.

7. The method of claim 1, further comprising:
selecting the time interval between the events from the set of possible time intervals based on the probabilities of the possible time intervals.

8. The method of claim 2, further comprising:
determining the set of the possible time intervals based on geometry of the bearing.

9. The method of claim 1, wherein the determining probabilities of occurrences of the events further comprising:
determining a set of local maxima values of the signal at corresponding times.
determining disturbance probability characteristics of the signal based on the local maxima values; and
determining a posterior probability function of the occurrence of the event based on the disturbance probability characteristics.

10. The method of claim 9, wherein the determining the set of local maxima values is based on a full width half maximum (FWHM) method.

11. The method of claim 9, wherein the disturbance probability characteristics include a prior probability of the occurrence of the event, a conditional probability of the occurrence of event, and a conditional probability of nonoccurrence of event.

12. The method of claim 11, wherein the determining disturbance probability characteristics further comprising:
determining the conditional probability of the occurrence of event as a maximum likelihood fit of a log-normal distribution to the set of local maxima values.

13. The method of claim 12, further comprising:
determining the conditional probability of the nonoccurrence of the event using expectation-maximization (EM) of the conditional probability of the occurrence of event.

14. The method of claim 12, further comprising:
determining the prior probability of the occurrence of the event using expectation-maximization (EM) of the conditional probability of the occurrence of event.
